(19) United States
(12) Patent Application Publication
(10) Pub. No.: US 2016/0254858 A1
(43) Pub. Date: Sep. 1, 2016

(54) SYSTEM AND METHOD FOR COMMUNICATION WITH AUTONOMOUS SYSTEM IN MULTIPLE BANDS

(71) Applicant: SPIRE GLOBAL, INC., San Francisco, CA (US)

(72) Inventors: Jeroen Cappaert, Sint-Gillis-Waas (BE); Bryan Wong, Seaside, CA (US)

(21) Appl. No.: 14/632,588

(22) Filed: Feb. 26, 2015

(51) Int. Cl. H04B 7/185; H04L 12/933

(52) U.S. Cl. CPC H04B 7/18523; H04B 7/18513; H04L 49/102; H04W 84/06

(57) ABSTRACT

A radio communications system and its method thereof handle radio communications for a small form factor satellite. The radio communications system may be implemented by a single printed circuit board. The single printed circuit board may include a UHF/VHF radio, an S-band radio and a processor. The processor may be coupled to the radios. The processor may receive radio messages from the UHF/VHF radio, and generate command signals based on the radio messages. The processor may transmit the command signals to a plurality of systems coupled to the radio communications system via a bus.

### CROSS REFERENCE TO RELATED PATENT APPLICATIONS

This disclosure incorporates by reference the following pending U.S. patent applications: (1) Ser. No. 14/515,142, title: Satellite Operating System, Architecture, Testing and Radio Communication System filed on Oct. 15, 2014; (2) Ser. No. 14/514,836, title: Back-Plane Connector for Cubesat filed on Oct. 15, 2014; and (3) Ser. No. 14/514,573, title: Novel Satellite Communication System filed on Oct. 15, 2014. The contents of these three applications are incorporated by reference herein as if each was restated in full.

### FIELD OF THE INVENTION

The inventions herein are directed to novel systems and methods for handling radio communications for an orbital satellite communication system. In particular, the present invention is directed to systems and method used to implement radio transmissions in a small factor satellites (known in the art as “cubesats”).

### BACKGROUND

A growing interest in low earth orbit satellites having a small form factor has led to an increase in both launches of the vehicles and the recognition that earlier techniques for control thereof are inadequate. Due to their smaller size, cubesats generally cost less to build and deploy into orbit above the Earth. As a result, cubesats present opportunities for educational institutions, governments, and commercial entities to launch and deploy cubesats for a variety of purposes with fewer costs compared to traditional, large satellites.

The cubesat performs radio transmissions with other satellites or ground stations in a radio communications network. However, radio transmission including parsing radio signals may be a daunting task, and may be time-strained and power-consuming. As such, there is a need for a fast, cost-efficient, and simplified mechanism to handle radio transmissions for the cubesat. Various embodiments of the disclosed technology address these needs.

### SUMMARY

The disclosed technology relates to a radio communications system for a small form factor satellite. The radio communications system may include a printed circuit board. The printed circuit board may include a UHF/VHF radio, an S-band radio and a processor coupled to the radios. The UHF/VHF radio may generate radio messages based on radio waves received by an antenna. The processor may handle radio communications for the satellite. Radio messages may reflect instructions for other systems or data for use in one or more systems. For instance, the processor may receive the radio messages from the UHF/VHF radio, and generate command signals based on the radio messages. The processor may transmit the command signals to a plurality of systems coupled to the radio communications system via a bus.

Another aspect of the disclosed technology relates to a radio communications system for a small form factor satellite. The radio communications system may include a first printed circuit board implementing a UHF/VHF radio. The UHF/VHF radio may generate radio messages based on radio waves received by an antenna. The radio communications system may also include a second printed circuit board implementing an S-band radio. The radio communications system may include a processor coupled to the radios. The processor may handle radio communications for the satellite. For instance, the processor may receive the radio messages from the UHF/VHF radio, and generate command signals based on the radio messages. The processor may transmit the command signals to a plurality of systems coupled to the radio communications system via a bus.

Various aspects of the described example embodiments may be combined with aspects of certain other example embodiments to realize yet further embodiments. It is to be understood that one or more features of any one example may be combined with one or more features of the other example. In addition, any single feature or combination of features in any example or examples may constitute patentable subject matter. Other features of the technology will be apparent from consideration of the information contained in the following detailed description.

### BRIEF DESCRIPTION OF THE DRAWINGS

The following Detailed Description of the technology is better understood when read in conjunction with the appended drawings. For the purposes of illustration, there is shown in the drawings exemplary embodiments, but the subject matter is not limited to the specific elements and instrumentalities disclosed. Components in the figures are shown for illustration purposes only, and may not be drawn to scale.

FIG. 1 illustrates an example terrestrial and orbital communication network according to one aspect of the disclosed technology.

FIG. 2 is a schematic drawing of a satellite according to one aspect of the disclosed technology.

FIG. 3 is a block diagram of satellite architecture according to one aspect of the disclosed technology.

FIG. 4 is a block diagram illustrating components of a single board design of the communications system according to one aspect of the disclosed technology.

FIG. 5 is a schematic illustration of connector layout in the communications system according to one aspect of the disclosed technology.

FIG. 6 is another schematic illustration of connector layout in the communications system according to one aspect of the disclosed technology.

FIG. 7 is a schematic illustration of a FARCOM UHF message format according to one aspect of the disclosed technology.

FIG. 8 is a flow chart illustrating steps performed by the communications system according to one aspect of the disclosed technology.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

1. Satellite Overview

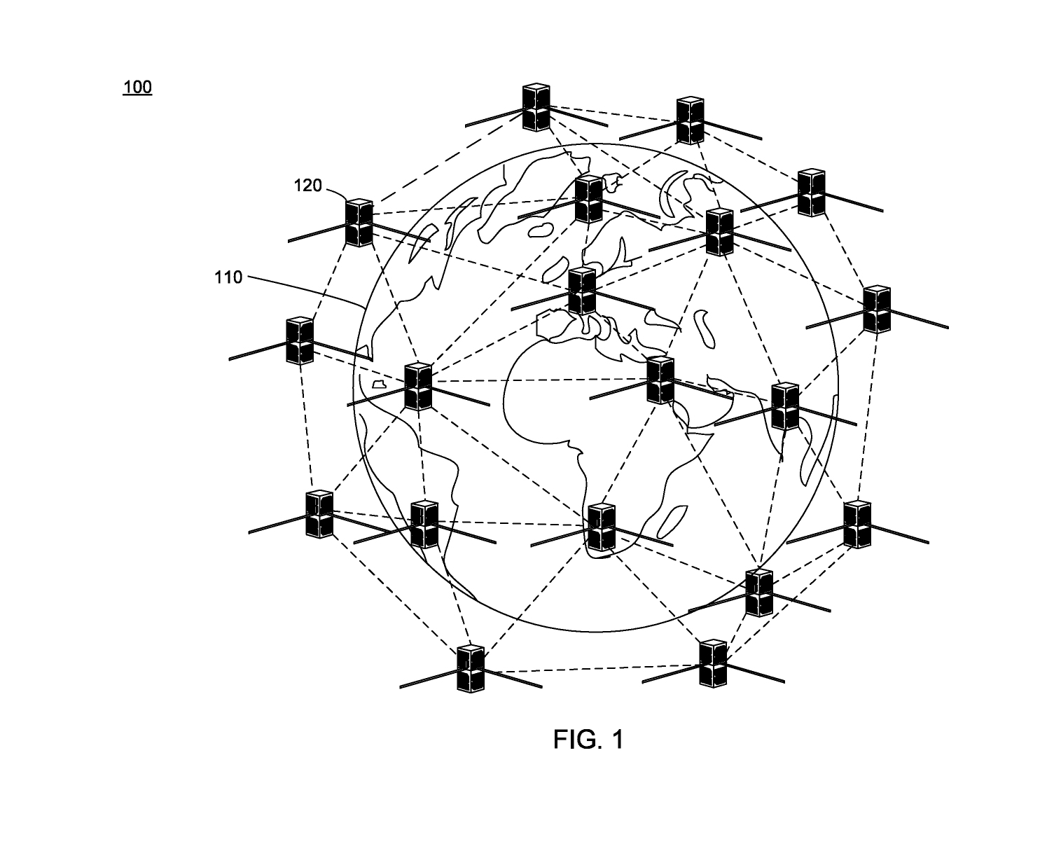

The present application relates to, but not limited to, a terrestrial and orbital communication network having a constellation of satellites. FIG. 1 illustrates an exemplary terrestrial and orbital communication network 100 covering at least a portion of a planet 110, such as the Earth. The network 100 may include a constellation of satellites 120 each configured to collect data from a point on the planet from time to time or on a regular basis. The satellite 120 may analyze the collected data to monitor maritime activities, including but not limited to tracking ship or oceangoing vessels, detecting illegal, unreported and unregulated fishing or pirate activities, monitoring trade transit, and detecting oil spill, among other possibilities.

The satellite 120 may be a cubesat having a small form factor. For instance, the size of the satellite 120 may be relatively small, in general not exceeding 10 cm×10 cm×30 cm and 10 kg of mass. In one embodiment, the satellite 120 may be based on an industry standard, developed in 2001 by Stanford University and California Polytechnic Institute and described in the document “CubeSat Design Specification.” Cubesats may be launched and deployed using a common deployment system. For example, cubesats may be launched and deployed from a mechanism called a Poly-PicoSatellite Orbital Deployer (P-POD). P-PODs may be mounted to a launch vehicle and carry cubesats into orbit. P-PODs may deploy cubesats once a proper signal is received from the launch vehicle.

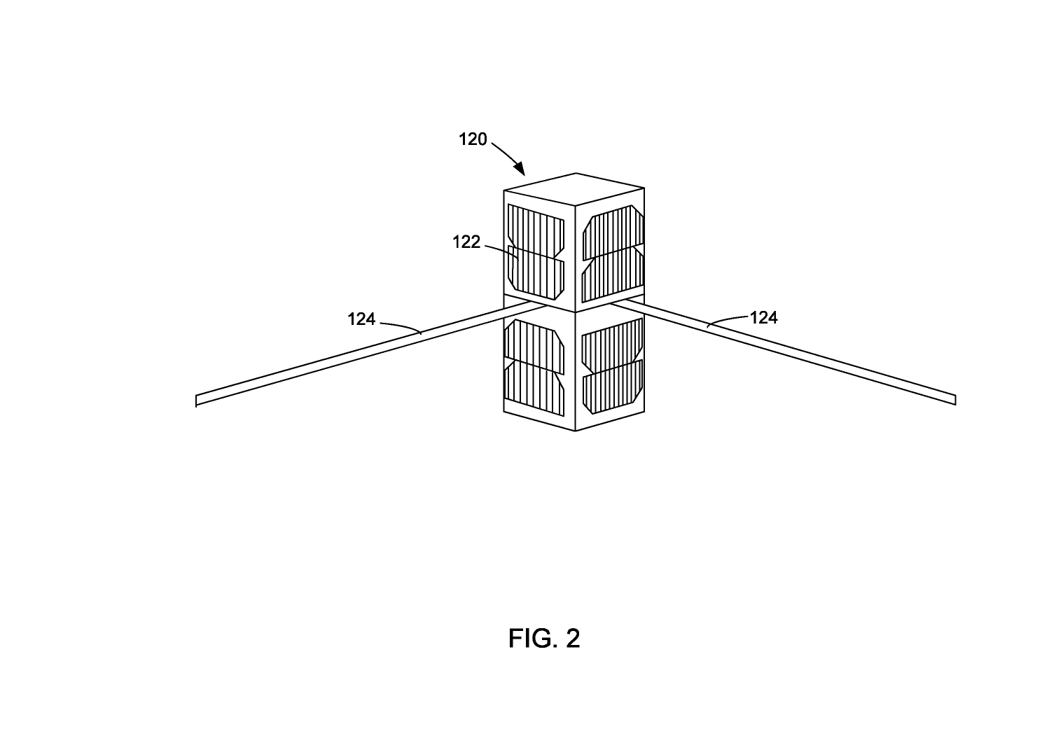

FIG. 2 is a schematic drawing of a satellite according to one aspect of the disclosed technology. As shown in FIG. 2, the satellite 120 may include one or more solar panels 122. The solar panels 122 may be configured to provide energy to one or more components contained within the satellite 120. The satellite 120 may also include one or more antennas 124 that may extend when fully deployed.

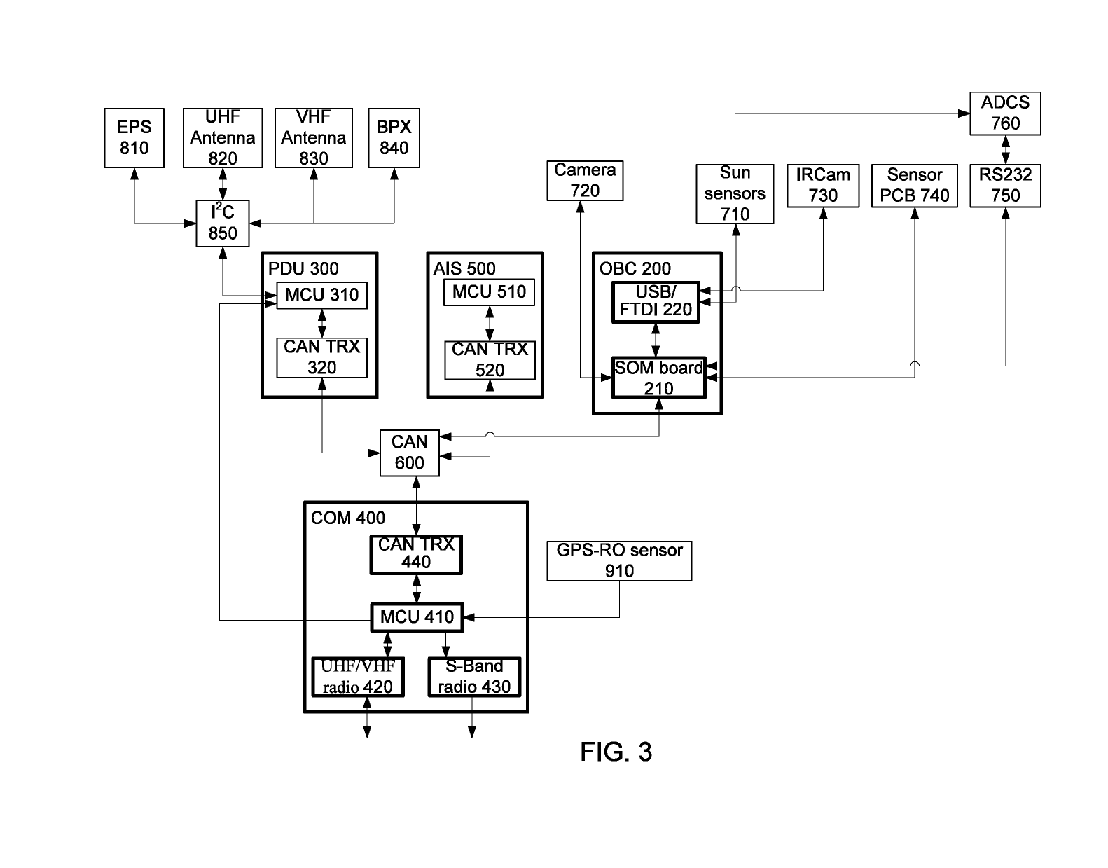

FIG. 3 illustrates an architecture design of the satellite 120 according to one aspect of the disclosed technology. As shown in FIG. 3, the satellite 120 may include an on-board computer (OBC) 200 that acts as a central computer, a power distribution unit (PDU) 300 that routes and regulates power throughout the satellite 120, and a communications system 400 configured to handle radio communications of the satellite 120. The satellite 120 may also include an automatic identification system (AIS) 500. The OBC 200, the PDU 300, the communications system 400, and the AIS 500 may communicate with one another via a controller area network (CAN) bus 600.

As shown in FIG. 3, the OBC 200 may include a System on Module (SOM) board processor 210 and a USB/FTDI connector 220. The PDU 300 may include a microcontroller (MCU) 310 and a CAN transceiver 320. The communications system 400 may include a MCU 410, radios such as a UHF/VHF radio 420 and an S-band radio 430, and a CAN transceiver 440. The AIS 500 may include a MCU 510 and a CAN transceiver 520.

In addition, the satellite 120 may also include one or more other systems, subsystems, components, devices, parts or peripherals. For example, the satellite 120 may include one or more sun sensors 710, one or more cameras such as a camera 720 and an infrared camera 730, a sensor printed circuit board (PCB) 740, RS232 750, and an attitude detection/control system (ADCS) 760 directly or indirectly coupled to the OBC 200. The satellite 120 may include an electrical power source (EPS) 810, a UHF antenna system 820, a VHF antenna system 830, and one or more batteries (BPX) 840, all of which may be coupled to the PDU 300 via an inter-integrated circuit (I²C) 850. Each antenna system may have one or more microcontrollers configured to perform a deployment of the antennas. Each antenna may have four antenna elements that may be deployed individually.

The satellite 120 may also include a GPS radio occultation receiver, such as a GPS radio occultation sensor (GPS-RO) receiver 910, coupled to the communications system 400.

Detailed discussions of the communications systems 400 are provided herein.

2. Communications System

The communications system 400 may be a portable communications system. The communications system 400 may receive a radio signal and communicate the radio signal to other systems, subsystems, apparatus, devices, components, parts and peripherals, which may be collectively referred to as systems.

With reference to FIG. 3, the communications system 400 may include a control unit (e.g., a microcontroller or MCU) 410. The control unit 410 may be a Class Cortex-M3 MCU. The control unit 410 may run a real time operating system, such as FreeRTOS. The control unit 410 may control and interact with radios 420 and 430.

The control unit 410 may communicate with a variety of systems including the OBC 200, the PDU 300 and may others via the CAN bus 600. The speed of such communication may be up to 100 Mbits/s. The control unit 410 may send direct commands to these systems via the CAN bus 600. For example, the control unit 410 may command hard resets to one or more systems via the CAN bus 600.

With continued reference to FIG. 3, the communications system 400 may include two radios, including a UHF/VHF radio 420 and an S-band radio 430. One or more radios may be off-shelf radios from vendors.

The communications system 400 may serve one or more purposes. For example, the communications system 400 may serve as a remote link to the OBC 200, and relieve the OBC 200 from any packet handling as well as any UART interrupts. For example, by implementing the UHF/VHF radio 420, the communications system 400 may act as a buffer between the UHF/VHF radio 420 and the OBC 200. In another example, by implementing the S-band radio 430, the communications system 400 may relieve the OBC 200 of any UART interrupt for S-band communications. The communications system 400 may also broadcast messages, such as beacon for identification purposes, to one or more other satellites or ground stations. Depending upon the power state, the communications system 400 may broadcast messages on a regular basis or upon demand.

The communications system 400 may have various configurations. In one embodiment, the communications system 400 may be implemented by a single printed circuit board. In another embodiment, the communications system 400 may be implemented by two printed circuit boards. Detailed discussions with regard to each configuration are provided herein.

### 2.1 Single Board Design

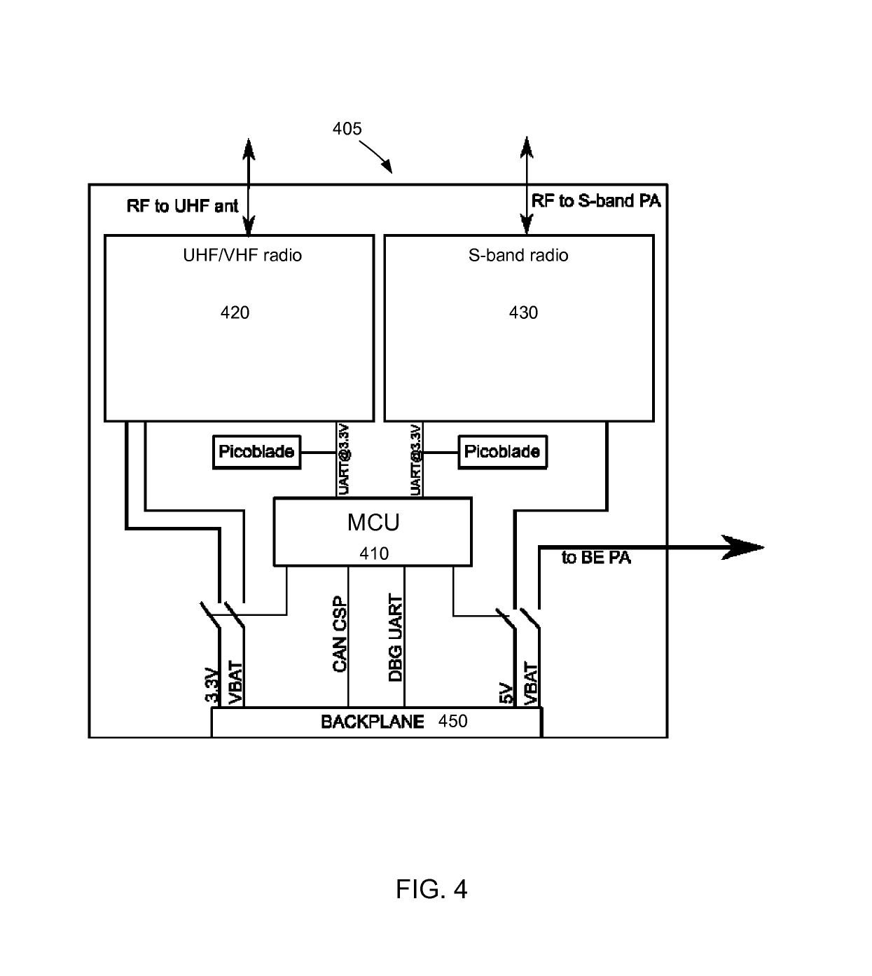

In the single board design, the communications system 400 may have its control unit and various radios integrated in a single board 405. FIG. 4 is a schematic illustration of the single board 405 with the control unit 410 and various radios 420 and 430 integrated therein. The control unit 410 may include an MCU. The control unit 410 may send commands to one or more remaining systems in the satellite 120. The control unit 410 may also include housekeeping information.

The radios may include the UHF/VHF radio 420, and the S-Band radio 430. The UHF/VHF radio 420 may generate radio messages based on radio waves received by an antenna. The S-band radio 430 may be configured to broadcast radio messages based on instructions from the control unit 410.

With continued reference to FIG. 4, the communications system 400 may include a backplane 450 that may serve as a backbone for connecting one or more printed circuit boards or systems to the communications system 400. The backplane 450 may include one or more electrical connectors and parallel signal traces that connect one or more printed circuit boards or systems to the communications system 400. Each pin of each connector may be linked to the same relative pin of all the other connectors to form a common computer bus.

### 2.1.1 User Interface

The communications system 400 may include a user interface that enables a user to issue commands to the communications system 400. The user may enter commands through a gosh terminal. The gosh terminal may be exposed to the user on either the communications system 400 or through nash. Details with respect to some of these commands are provided herein. Table 1 below illustrates example commands of the communications system 400. Actual command nomenclature may be dictated in part by the operating system or programming language and processor selection.

TABLE 1
User interface commands of the communications system

| Command | |
|---|---|
| No. | Description |
| 1 | Resets the PDU 300 directly (through a GPIO line) <optional |
| | timeout ms>. |
| 2 | Reset the OBC 200 directly (through a GPIO line) <optional |
| | timeout ms>. |
| 3 | Configures the OBC 200 boot mode. |
| 4 | Retrieve the OBC 200 boot mode |
| 5 | housekeeping info of the communications system |
| | 400. <optional timeout ms> |
| 6 | return current bootcount of the communications system |
| | 400 <optional timeout ms> |
| 7 | zero out bootcount to delay the periodic factory |
| | reset <optional timeout ms> |

Command No. 1 may reset the PDU 300 directly, e.g., through a general purpose input/output (GPIO) line.

Command No. 2 may reset the OBC 200 directly, e.g., through a GPIO line. An optional timeout parameter may be used in conjunction with Command No. 2.

Command No. 3 may configure a boot mode of the OBC 200.

Command No. 4 may retrieve information about the boot mode of the OBC 200.

Command No. 5 may retrieve housekeeping formation of the communications system 400. An optional timeout parameter may be used in conjunction with Command No. 5.

Command No. 6 may return a current boot count (or bootcount) value of the communications system 400. An optional timeout parameter may be used in conjunction with Command No. 6.

Command No. 7 may zero out the boot count of the communications system 400 to delay the periodic factory reset. An optional timeout parameter may be used in conjunction with Command No. 7.

The communications system 400 may have commands to configure beacon messages and inquire status thereof. Table 2 below illustrates example descriptions of beacon commands.

TABLE 2
Beacon commands

| Command | |
|---|---|
| No. | Description |
| 8 | Resets the PDU 300 <optional timeout ms> |
| 9 | set how long beacon waits if other traffic is occurring |
| | (in secs) |
| 10 | set the timeout for gathering requests between subsystems |
| | (in ms) |

For example, Command No. 8 may reset the PDU 300. An optional timeout parameter may be used in conjunction with Command No. 8.

Command No. 9 may set how long beacon waits if other traffic is occurring. The waiting period may be set in seconds.

Command No. 10 may set a timeout for gathering requests between systems. The timeout period may be set in milliseconds.

Additionally, the communications system 400 may have commands to configure each radio and inquire status of each radio. Further, the communications system 400 may have commands to configure a GPS-RO sensor and inquire status thereof.

### 2.1.2 Connectors

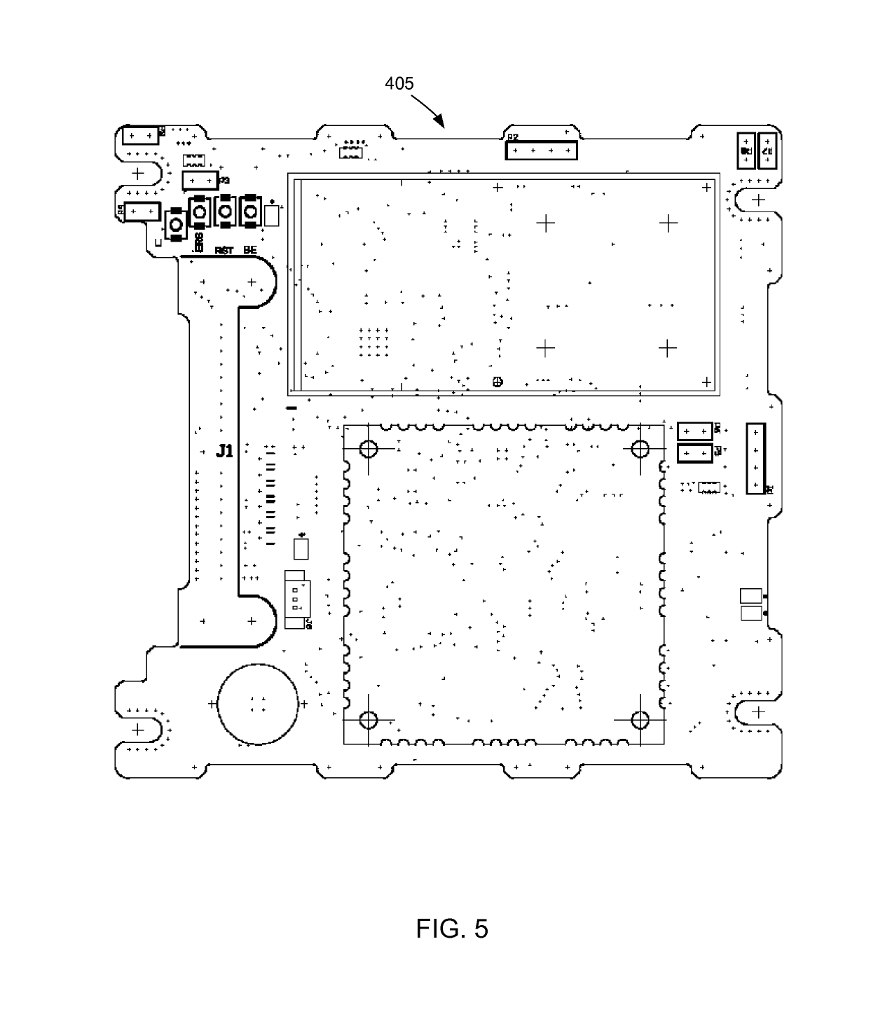

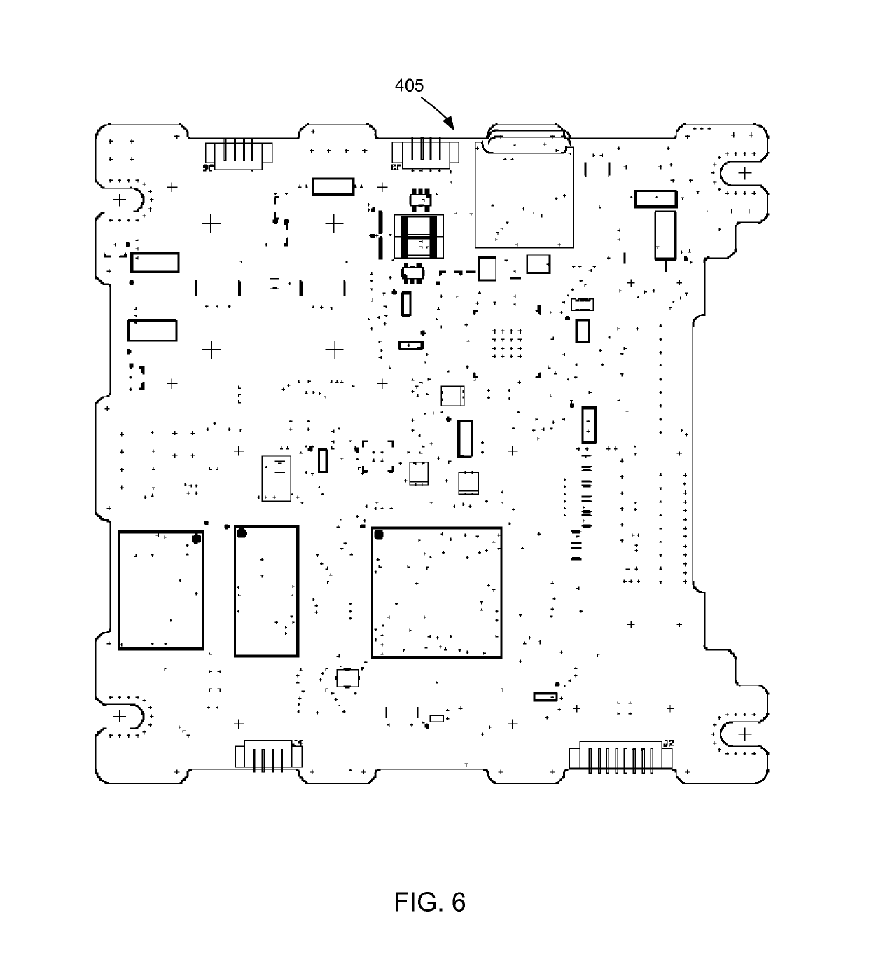

FIGS. 5-6 are schematic illustrations of connector layout in the single board design according to one aspect of the disclosed technology. According to one embodiment, the single board 405 may have a top side with one or more of the following connectors: USB micro connector, backplane connector, extra UART breakout, UART breakouts, power breakout, USB power jumper, CAN breakout, VHF radio MCU power jumper, UHF radio MCU power jumper, VHF radio power amp power jumper, UHF radio power amp power jumper, and LED power jumper.

The USB micro connector may connect to an FTDI USB to 4x serial port converter. The USB micro connector may include one or more ports with one or more of the following connections: Debug UART, VHF radio UART, UHF radio UART, and MCU UART2.

The extra UART breakout may include one or more pins associated with one or more of the following functions: transmit data (e.g., TXD2), receive data (e.g., RXD2), and ground (e.g., GND).

The UART breakouts may include one or more pins associated with one or more of the following functions: VHF radio RX, VHF radio TX, UHF radio RX, and UHF radio TX.

The power breakout may include one or more pins associated with one or more of the following functions: VBAT, 3.3V, 5V, and GND.

The USB power jumper may include one or more pins associated with one or more of the following functions: 5V USB and 5V in.

The CAN breakout may include one or more pins associated with one or more of the following functions: high voltage signal (e.g., CANH) and low voltage signal (e.g., CANL).

The VHF radio MCU power jumper may include one or more pins associated with one or more of the following functions: 5V and VHF radio VIN.

The UHF radio MCU power jumper may include one or more pins associated with one or more of the following functions: 3.3V and UHF radio VIN.

The VHF radio power amp power jumper may include one or more pins associated with one or more of the following functions: VBAT and VHF radio PA VIN.

The UHF radio power amp power jumper may include one or more pins associated with one or more of the following functions: VAT and UHF radio PA VIN.

The LED power jumper may include one or more pins associated with one or more of the following function: ground (e.g., GND and LED_GND).

According to one embodiment, the communications system 400 may have a bottom side with one or more of the following connectors: MCU JTAG, VHF radio programming, BE power amp connector, and USB FTDI.

The MCU JTAG may have one or more pins associated with one or more of the following functions: TCK, TDI, TDO, TMS, RST, 3.3V, and GND.

The VHF radio programming may have one or more pins associated with one or more of the following functions: 3.3V, SBW DIO, SBW CLK, and GND.

The BE power amp connector may have one or more pins associated with one or more of the following functions: VHF radio PA VIN and GND.

The USB FTDI may have one or more pins associated with one or more of the following functions: GND, D+, D−, and 5V USB.

### 2.2. Dual Board Implementation

According to another aspect of the disclosed technology, the communications system 400 may include a dual board system to accommodate custom radios on different boards. For instance, in the dual board system, the UHF/VHF radio 420 may be disposed directly on a first custom board, and the S-band radio 430 may be disposed directly on a second custom board. The first board may be referred to as “FARCOM,” and the second board may be referred to as “FLASH.” In the dual board system, the radios may be custom-made radios instead of vendor supplied radios. For example, the S-band radio 430 placed on the FLASH board may be a custom-made high speed radio.

A FARCOM board in the dual board design of the communications system 400 may have an architecture design similar to the single board design of the communications system 400 as illustrate in FIG. 4.

The FARCOM board may include a custom UHF/VHF radio 420 instead of an off-shelf radio. The custom UHF/VHF radio 420 may be implemented by a radio frequency integrated circuit (RFIC). For example, a custom UHF radio may be implemented by a low-power transceiver for wireless applications. A transceiver may be used for a radio frequency of 2.4 GHz. Table 3 below illustrates a default configuration of a custom UHF radio according to one embodiment of the disclosed technology.

TABLE 3
Default configuration of a custom UHF radio

| Property Name | Property Value |
|---|---|
| RF Frequency: | 433.000 MHz (configurable at runtime) |
| Baudrate: | 9600 bps (configurable at runtime) |
| Preamble: | yes - 12 bytes (configurable at runtime) |
| Modulation: | GFSK (configurable at runtime) |
| Sync word: | yes - 0xD3, 0x91, 0xD3, 0x91 |
| CRC: | yes, 2-bytes CRC-16; autoflush |
| Data Whitening: | None |
| Addressing: | not use |
| Channels: | not used |

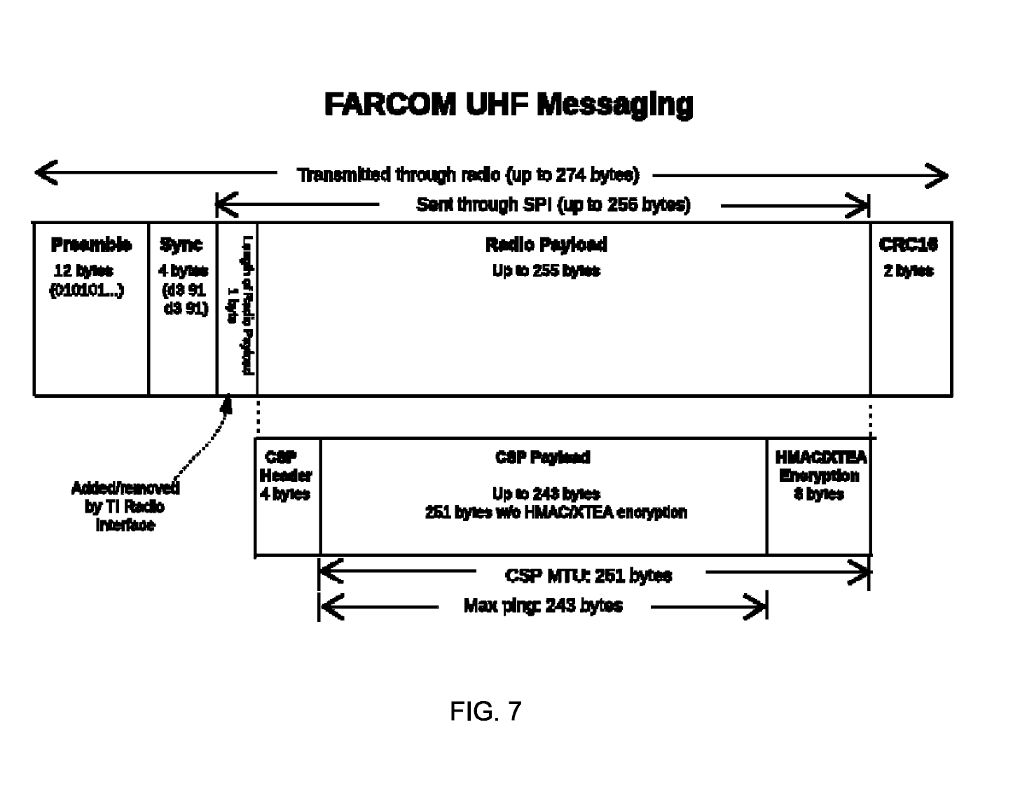

FIG. 7 displays an example UHF message format implemented by the FARCOM board design. As illustrated, the message may include one or more of the following: a preamble having 12 bytes, a sync portion having 4 bytes, 1 byte indicating a length of radio payload, a radio payload having a size up to 255 bytes, and a cyclic redundancy check having 2 bytes. In another aspect, the message may include a CSP header having 4 bytes, a CSP payload having a size up to 243 bytes, and a HMAC/XTEA encryption having 8 bytes.

### 2.2.1 User Interface

The FARCOM board may include a user interface that enables a user to issue commands to the communications system 400.

For instance, the user may access configurations of the UHF radio via a remote procedure call (RPC). Table 4 below illustrates example UHF configuration commands.

TABLE 4
UHF configuration commands

| | | Usage |
|---|---|---|
| Command | | (additional |
| No. | Description | arguments) |
| 11 | send full configuration as | None |
| | currently saved in SW | |
| 12 | set the UHF radio | <baudrate in bps> |
| | symbol/data/baudrate, and | |
| | modem deviation accordingly | |
| 13 | set the UHF radio frequency | <frequency in KHz> |
| 14 | set the UHF radio packet format | <{normal,random}> |
| | mode (random for test) | |
| 15 | set the UHF radio preamble size | <preamble size in bytes: |
| | in bytes | {2,3,4,6,8,12,16,24}> |
| 16 | set the RF modulation | <{GFSK,2FSK,4FSK,MSK,ASK_OOK}> |

The user may also access status of the UHF radio via RPC by entering a UHF status command. The status command may return a summary of UHF radio status, UHF configurations, a current FARCOM control state and interface statistics. The interface statistics include information such as the number of ISRs. The command may be used in conjunction with an argument, which may provide a more detailed status and configuration registers that may be used for debugging purposes.

The reset command may turn off the UHF chip, and turn it back on. Once the chip is powered back on, the chip may be configured and calibrated.

The user may debug the UHF radio with one or more UHF debugging commands illustrated in Table 5 below.

TABLE 5
UHF debugging commands

| | | usage |
|---|---|---|
| Command | | (additional |
| No. | description | arguments) |
| 17 | Force UHF microcontroller's current Finite | <{rx,tx,idle,calibrate}> |
| | State Machine mode to RX mode, TX mode, | |
| | IDLE mode, or CALIBRATE mode. Note that | |
| | some modes, depending on configuration, will | |
| | jump to other modes based on specific | |
| | conditions; so these commands are not | |
| | necessarily permanent. | |
| 18 | A routine which sends raw test packets | [ number of messages |
| | (bypassing CSP). It intends to run forever, | to send ] [ size in |
| | but optionally, the user can specify a finite | bytes ] [ wait in ms] |
| | number of messages to write, a finite size in | |
| | bytes, and a wait time between transmissions. | |
| 19 | Spawn debug task to monitor events in FSM | none |
| | and FIFOs | |

The user may enter commands for storing and recalling UHF configurations from a FARCOM's serial flash via RPC. Such commands are illustrated in Table 6 below.

TABLE 6
UHF flash commands

| | | usage |
|---|---|---|
| Command | | (additional |
| No. | Description | arguments) |
| 20 | Store the entire current configuration of | None |
| | the UHF Radio into FARCOM serial flash | |
| 21 | Reload the serial flash stored configuration | None |
| | into the UHF Radio | |
| 22 | Reset the serial flash stored configuration | None |
| | AND the UHF Radio configuration to the | |
| | defaults. | |

The user may enter commands for debugging UHF power via RPC. Such commands are illustrated in Table 7 below.

TABLE 7
UHF power debugging commands

| | | usage |
|---|---|---|
| | | (additional |
| Command | Description | arguments) |
| 23 | Switch off or on the UHF transceiver | <state: {off,on}> |
| | power. | |
| 24 | Switch off or on the UHF Low Noise | <state: {off,on}> |
| | Amplifier power. | |
| 25 | Switch off or on the UHF Power | <state: {off,on}> |
| | Amplifier power | |
| 26 | Set the Power Amplifier VREF through | <voltage)> |
| | the DAC (The range is: 0 v-3.3 v) | |
| 27 | Set the RF switches for the RX path | None |
| 28 | Set the RF switches for the TX path | None |

The user may access system and housekeeping information of the FARCOM via RPC by entering commands illustrated in Table 8 below.

TABLE 8
System and housekeeping FARCOM commands

| | | usage |
|---|---|---|
| | | (additional |
| Command | Description | arguments) |
| 29 | farcom housekeeping info, including | none |
| | temperature | |
| 30 | return current bootcount | None |
| 31 | zero out bootcount to delay the periodic | None |
| | factory reset | |

### 2.2.2 Connectors

According to one embodiment, the FARCOM board may have one or more test points associated with one or more of the following functions: 3.3V UHF power amp, GDOO, 3.3V, 5V UHF LNA, VBAT ADC, 5V ADC, 3.3V ADC, MCU 3.3V, MCU 1.8V, FTDI 3.3V, and USB 5V.

### 2.3 Operations of the Communications System

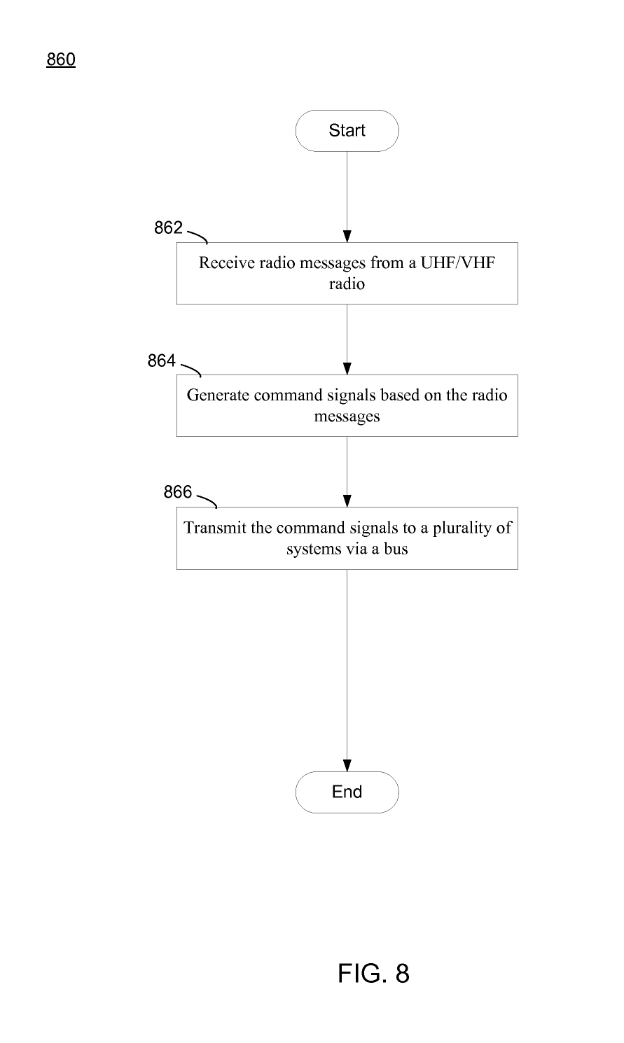

FIG. 8 is a flow chart 860 illustrating example steps that may be executed by the communications system 400 to handle radio communications for the satellite 120.

At 862, the control unit 410 of the communications system 400 may receive radio messages from the UHF/VHF radio 420. The UHF/VHF radio 420 may generate the radio messages based on radio waves received by an antenna. At 864, the control unit 410 may generate command signals based on the radio messages. At 866, the control unit 410 may transmit the command signals to a plurality of systems in satellite 120 via the CAN bus 600.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation. For example, the disclosed technology may be implemented in an aerospace device or system, including but not limited to, satellite communication systems of all sizes, and aircrafts including airplanes, jets, and air balloon, among other possibilities. The disclosed technology may serve multiple purposes, including monitoring maritime activities, monitoring trade transit, general aviation, commercial and private purposes including transport and cargo services, and military purposes, among other possibilities.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claim is:

1. A radio communications system for a small form factor satellite, comprising:
a printed circuit board including:
a UHF/VHF radio generating radio messages based on radio waves received by an antenna;
an S-band radio; and
a processor coupled to the radios, the processor handling radio communications for the satellite by:
receiving the radio messages from the UHF/VHF radio;
generating command signals based on the radio messages; and
transmitting the command signals to a plurality of systems that are coupled to the radio communications system via a bus.

2. The system of claim 1, wherein the bus is a controller area network bus.

3. The system of claim 1, wherein the plurality of systems include an on-board computer and a power distribution unit.

4. The system of claim 1, wherein the processor issues a hard reset command to at least one of the plurality of systems.

5. The system of claim 1, wherein the UHF/VHF radio is a UHF radio.

6. The system of claim 1, wherein the printed circuit board includes a backplane having a plurality of connectors that physically connect the processor to the plurality of systems.

7. The system of claim 6, wherein the plurality of connectors include USB micro connector, backplane connector, extra UART breakout, UART breakouts power breakout, USB power jumper, CAN breakout, VHF radio MCU power jumper, UHF radio MCU power jumper, VHF radio power amp power jumper, UHF radio power amp power jumper, LED power jumper, MCU JTAG, VHF radio programming, BE power amp connector, and USB FTDI.

8. The system of claim 1, further comprising a user interface for receiving a user-initiated command to the radio communications system.

9. The system of claim 1, wherein the processor instructs at least one of the radios to broadcast a message.

10. The system of claim 9, wherein the message identifies the satellite in a radio communications network.

11. The system of claim 1, wherein the S-band radio is configured to broadcast radio messages based on instructions from the processor.

12. A radio communications system for a small form factor satellite, comprising:
a first printed circuit board implementing a UHF/VHF radio, the UHF/VHF radio generating radio messages based on radio waves received by an antenna;
a second printed circuit board implementing an S-band radio; and
a processor coupled to the radios, the processor handling radio communications for the satellite by:
receiving the radio messages from the UHF/VHF radio;
generating command signals based on the radio messages; and
transmitting the command signals to a plurality of systems coupled to the radio communications system via a bus.

13. The system of claim 12, wherein the first printed circuit board includes a user interface for receiving a user-initiated command to the radio communications system.

14. The system of claim 12, wherein the radios are custom-made radios.

15. The system of claim 12, wherein the processor instructs at least one of the radios to broadcast a message.

16. The system of claim 15, wherein the message identifies the satellite in a radio communications network.

17. The system of claim 12, wherein the bus is a controller area network bus.

18. The system of claim 12, wherein the plurality of systems include an on-board computer and a power distribution unit.

19. The system of claim 12, wherein the S-band radio is configured to broadcast radio messages based on instructions from the processor.
